(19) United States
(12) Patent Application Publication
(10) Pub. No.: US 2018/0119978 A1
(43) Pub. Date: May 3, 2018

(54) Thermostat for Heating, Air-Conditioning and/or Ventilation Systems

(71) Applicants: Gernot Becker, Dortmund (DE); Markus Hammer, Ludenscheid (DE); Daniel Niehues, Duisburg (DE)

(72) Inventors: Gernot Becker, Dortmund (DE); Markus Hammer, Ludenscheid (DE); Daniel Niehues, Duisburg (DE)

(73) Assignee: innogy SE, Essen (DE)

(21) Appl. No.: 15/857,868

(22) Filed: Dec. 29, 2017

Related U.S. Application Data
(63) Continuation of application No. PCT/EP2016/055297, filed on Mar. 11, 2016.

(30) Foreign Application Priority Data
Jul. 1, 2015 (DE) 10 2015 110 583.7

(51) Int. Cl. F24F 11/523; G01K 1/06; G05D 23/19

(52) U.S. Cl. CPC F24F 11/523; F24F 2120/20; G05D 23/1904; G01K 1/06

(57) ABSTRACT

Embodiments of a thermostat for heating, air-conditioning and/or ventilation systems are provided. The thermostat includes a base body, a temperature sensor arranged on the base body, an actuator arranged on the base body, and a housing that at least partially encloses the base body. A display is made possible in that the housing in the area of the base body is at least in parts made of a translucent material.

### CROSS-REFERENCE TO RELATED PATENT APPLICATIONS

This patent application is a continuation of PCT/EP2016/055297, filed Mar. 11, 2016, which claims priority to German Application No. 10 2015 110 583.7, filed Jul. 1, 2015, the entire teachings and disclosure of which are incorporated herein by reference thereto.

### FIELD OF THE INVENTION

The object relates to a thermostat for heating, air-conditioning and/or ventilation systems. Insofar as in the following the term heating is used, this always also relates, alternatively or cumulatively, to an air-conditioning and/or ventilation system.

### BACKGROUND OF THE INVENTION

In the field of home automation, the control and regulating of heat controllers, i.e. thermostats, plays an important role. Within the framework of home automation a thermostat is, as a rule, the device that has the greatest cost saving potential in that temperature regulation is optimised. By suitable control/regulation of the thermostat, while ensuring comfort for the user, at the same time cost savings can be realised.

The basic function of a thermostat, with which a setting element, usually via a spindle, adjusts a control valve inside the heating element, is known as such. It is also known that thermostats can be tied into home automation solutions and be adjusted by means of a central control. The simple and intuitive operation of the thermostats is, however, a very important aspect for acceptance by the user. The thermostat itself forms a direct interface between the home automation system and the user and should offer the latter operating experience that is as comfortable as possible. In addition, the actual setting of the thermostat should be indicated to the user as simply and intuitively as possible and make it intuitively easier to change the settings.

For this reason it was the object to make available a thermostat which permits particularly easy operation by the user.

### BRIEF SUMMARY OF THE INVENTION

This object is achieved objectively by a thermostat according to embodiments described herein.

It was found that the essential technology can be incorporated in a base body of the thermostat. In addition to a temperature sensor this can also be an actuator with which a control valve inside a heating element or another air-conditioning or ventilation system can be adjusted. The technology installed in the base body is protected from the user by a housing that at least partially surrounds the base body.

So that during the use of the thermostat the user can obtain information about the current setting and measured value of the thermostat as unimpeded as possible, it was found that the indication can take place directly in the area of the housing. In this instance this is achieved in a particularly simple manner in that in the area of the base body the housing is made at least in parts of a translucent material. This translucent material makes it possible to transmit a signal from inside the housing to the outside without the details of the technology installed in the base body being visible. The housing is in parts made like frosted glass. In these parts lights shines diffusely through the housing, so that with illuminants an information indication can take place to the outside. By an illuminant arranged inside the housing a signalling of points or ranges, preferably along a scale, can be signalled, and the light of the illuminant shines through the housing in the translucent areas.

For the light of the illuminant to shine through it has been found that an opacity of the translucent material of at least 1.5 is advantageous. An opacity of at least 2, but an opacity of less than 10, is also advantageous for the present application. Opacity in the sense of the application can be understood as the reciprocal of the transmission, respectively as quotient from the incident luminous flux and the transmitted luminous flux.

As already explained, a illuminant can be provided on the base body. The illuminant can in particular be arranged on the base body on the side facing the housing, especially in the area of the translucent material of the housing. For the indication of setpoint and actual values of a temperature or other measured values, it may be expedient when the illuminant is two-coloured. An LED strip is particularly advantageous, on which LEDs of different radiation characteristics, in particular with different wavelengths of the radiated light, are arranged next to one another. It was found that at least two colours, in particular red and green are advantageous. However, it is also possible to additionally provide a yellow LED as well as a blue LED.

The illuminant is preferably an illuminant extending in the longitudinal direction, which extends along the casing surface (lateral surface) of the base body. The illuminant could extend here along a circumference or in the longitudinal direction. Preferably the illuminant spans a circular segment of at least 45°, preferably up to 90°. In the installed state the thermostat can then be arranged on the heating system in such a way that the area of the base body which is provided with an illuminant points upwards. This provides the user with the easiest possibility of reading the information indicated on the illuminant.

For arranging the illuminant on the base body, it is advantageous when the illuminant is bar-shaped in the form of a strip or the like. The illuminant can then advantageously be arranged in a radial recess provided in the outer surface of the base body. This facilitates the pushing of the housing onto the base body, since the illuminant then preferably does not project beyond the outer surface of the base body or does so only slightly.

In order to be able to assign settings or measured values to a value range, a scale is required. This scale can then preferably be arranged on the housing. The scale can, for example, depict a temperature scale, e.g. from 10° C. to 40° C. or also a pure linear scale from 0 to 6 or similar. The range of the scale can be illustrated by scale marks. Such a scale can be arranged on the housing, in particular by imprinting, embossing or similar. In particular, such a scale can be provided either in the area of the casing surface (lateral surface) or in the area of the front face of the housing. It is preferable when the scale is provided in the area of the translucent material of the housing. If the illuminant extends lengthwise and can be controlled differently along its longitudinal extent, by setting the length of an activated range of the illuminant, the scale arranged correspondingly above the illuminant can be illuminated. The length of the activated range of the illuminant can be assigned a value range with the aid of the scale.

According to an embodiment it is proposed that the scale is stationary relative to the illuminant. Especially in the installed state of the housing on the base body, the housing is arranged on the base body in such a way that it cannot turn. By proximity sensors arranged in the base body a rotation of objects, e.g. of the hand along the housing can be detected and this rotation can be evaluated as an operating of the thermostat. When such an operation is registered, a control circuit can control, in particular activate, the illuminant in dependence on this operation. At the end of an operation, in particular after a pre-set time, the illuminant can be deactivated again.

According to an embodiment it is proposed that a control circuit controls the illuminant dependant on a setpoint temperature and an actual temperature detected by a temperature sensor. Thus, for example, during an ascertained approaching of an object, e.g. a hand towards the housing, first the illuminant can be activated in such a way that in a first colour an actual temperature value is shown and in a second colour a setpoint temperature value is shown. Thus, for example, the length of the activated range (of the bar) of the illuminant on the scale can represent an actual temperature value in relation to a setpoint temperature value. If the control circuit for controlling the illuminant has been activated, the control circuit can be set in such a way that a first colour of the illuminant is activated in dependence on the setpoint temperature and/or that a second colour of the illuminant is activated dependant on the actual temperature. With this it is possible that by the control circuit both colours of the illuminant are activated simultaneously. So it is possible that the illuminant comprises at least two light bars extending parallel to one another, wherein the length of the activated range of a respective illuminant can be adjusted by means of the control circuit. So a first illuminant can be controlled in such a way that the length of the active range corresponds to the current actual temperature in relation to the scale. If the scale can, for example, illustrate 10 to 30° C. and the actual temperature is 20° C., then the length of the activated range of the illuminant can, for example, constitute exactly half the length of the entire illuminant. The same applies to the setpoint temperature. If the setpoint temperature is set to the maximum temperature, then for the indication of the setpoint temperature the illuminant can be activated completely, i.e. the illuminant is activated over its entire length.

Preferably it is possible to show the user when the actual temperature has reached the setpoint temperature. This can be done by the control circuit carrying out a comparison of the actual temperature with the setpoint temperature. Depending on this comparison the control circuit can activate the illuminant. If the actual temperature differs from the setpoint temperature by less than a minimum distance, e.g. 5° C., 3° C., 1° C. or also only 0.5° C., a third colour of the illuminant can be activated and in this way inform the user that the actual temperature corresponds to the setpoint temperature. Also, a pulsed controlling of the illuminant can take place, so that, for example, by a flashing of the illuminant the user is informed that the actual temperature corresponds to the setpoint temperature. The minimum distance can be parameterised in the control circuit. Also, the length of the activated range of the illuminant can in this case again correspond to the relative position of the actual temperature on the scale.

It is also possible that in the control circuit a time is estimated when an actual temperature reaches a setpoint temperature, preferably a newly set setpoint temperature. For this, first a comparison is carried out between the actual temperature and the set setpoint temperature. Depending on an estimation algorithm, in which for example a heat capacity of a room may also be parameterised, it can now be estimated how long it will take before the actual temperature reaches the setpoint temperature. The feed temperature of the heating element can also be taken into account for this. Depending on the estimated time, the illuminant can be activated. Also, here the scale used for indicating the actual and setpoint temperature can be used. If, for example, the scale is arranged on the housing over an angle section of 30°, each angle section of 1° can, for example, correspond to one minute. If the time is estimated at 25 minutes, the illuminant can be controlled in such a way that the length of the activated range covers 25° of the angle section of the scale.

As already mentioned, with the aid of the scale the relative position of the temperature respectively the time can be indicated in relation to an upper and lower limit of the scale. With the aid of the control circuit the illuminant can be controlled in such a way that a length of an activated section of a colour of the illuminant corresponds to a temperature or time. The higher the temperature, the longer the activated section will be. If the temperature is at a pre-set maximum temperature, the entire illuminant can be activated, in particular over its entire length. Also, a time can be indicated, which is represented by the scale. When this time is reached or exceeded, the entire length of the illuminant can be activated. If the time lies below the maximum time which is represented by the scale, a corresponding section of this time can be shown by the activation of a corresponding length of a section of the illuminant in relation to the overall length.

During an adjusting of the setpoint value of the temperature, in particular during manual adjusting, it is possible that first the length of the activated area of the illuminant corresponds to the previous value and the length of the activated area is changed relative to the change of the setpoint value, so that the changed span of the setpoint value is indicated. In particular the former setpoint temperature can be represented by a length of the activated section of a first illuminant, a length of an activated section of a second illuminant can represent the change of the setpoint temperature and a length of an activated section of a third illuminant can represent the new setpoint temperature.

As already mentioned, the housing can be cylindrical. In this case it is preferably in parts hollow cylindrical with a base and a casing. In particular the housing is arranged with its base on the front side of the base body.

In the joined state the housing is held on the base body in such a way that it cannot turn in relation to the base body. This also ensures that the relative position, especially the angle position of the illuminant which is held on the base body, is stationary relative to the housing.

With the aid of a sensor, preferably a proximity sensor, an object close to the housing can be detected. To this end it is proposed that at least one sensor is arranged on the base body, with which a rotary movement of at least one object in the area outside the housing around the longitudinal axis of the housing can be detected. Such a sensor preferably is a contactless, especially capacitive proximity sensor. When a movement, especially an approach is detected, the control circuit can first actuate the illuminant in such a way that the setpoint and actual temperatures are indicated by corresponding bars of the illuminant. The user can then carry out a change of the setpoint temperature, which is indicated by a change in the lengths of the activated sections of the illuminant. Such a change can be carried out by a detected rotary movement in the area of the outside of the housing. When the user or the object moves away from the sensor and accordingly from the thermostat, this can be detected and subsequently a follow-up time of a few seconds can be parameterised in the control circuit, during which the illuminant remains activated, to subsequently be deactivated. Also, following an adjusting and a moving away of the object, a time can be indicated how long it will take until the actual temperature will have reached the setpoint temperature, as has already been described above.

Also, a front side sensor can be provided. According to an exemplary embodiment this can also be an additional pressure or touch sensor. The user can, for example, by touching the front activate an indication which shows the present actual temperature as well as the setpoint temperature by corresponding lengths of the activated areas of the illuminant.

The activation of the illuminant can also take place dependant on a detected rotary movement or a detected approach or a detected pressure on the housing. This ensures that the illuminant is only activated when a user wants to carry out an operation. In all other cases the illuminant is inactive, so that energy is saved.

### BRIEF DESCRIPTION OF THE SEVERAL VIEWS OF THE DRAWING

In the following the subject matter will be explained in more detail with reference to a drawing showing exemplary embodiments. In the drawings:

FIG. 1 shows a schematic sectional view of a conventional thermostat;

FIG. 2 shows a schematic side view of a thermostat according to an embodiment;

FIG. 3 shows a view of a base body according to an embodiment;

FIG. 4 shows a view of a casing according to an embodiment;

FIG. 8 shows a sectional view through a casing according to an embodiment;

FIG. 6a shows a side view of a base body with a casing according to an embodiment;

FIG. 6b shows a sectional view of a base body with a casing according to an exemplary embodiment;

FIG. 7a shows two proximity sensors with an object;

FIG. 7b shows two proximity sensors with an object;

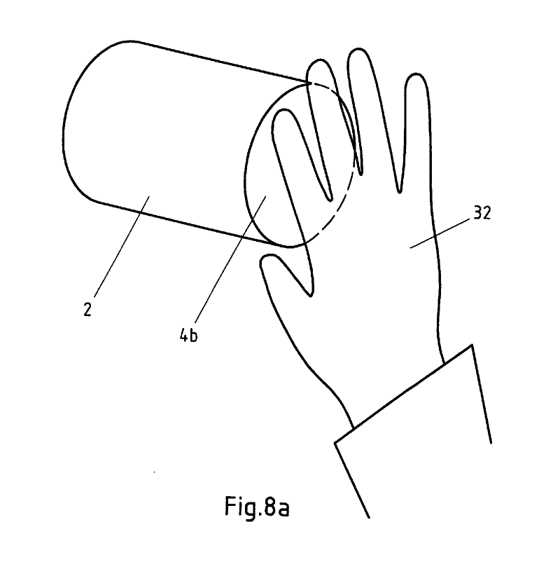

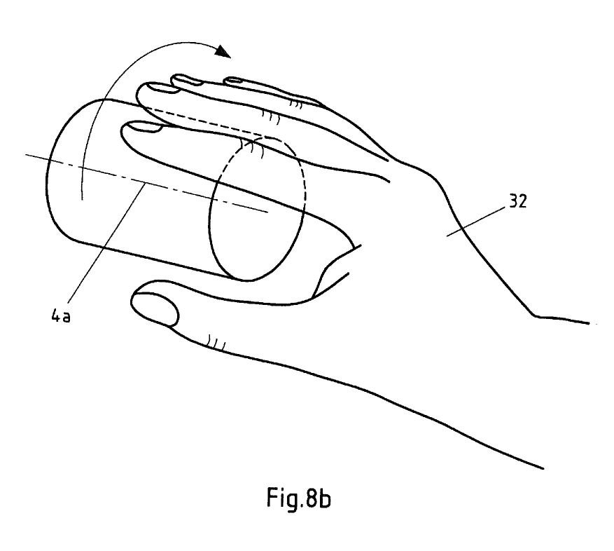

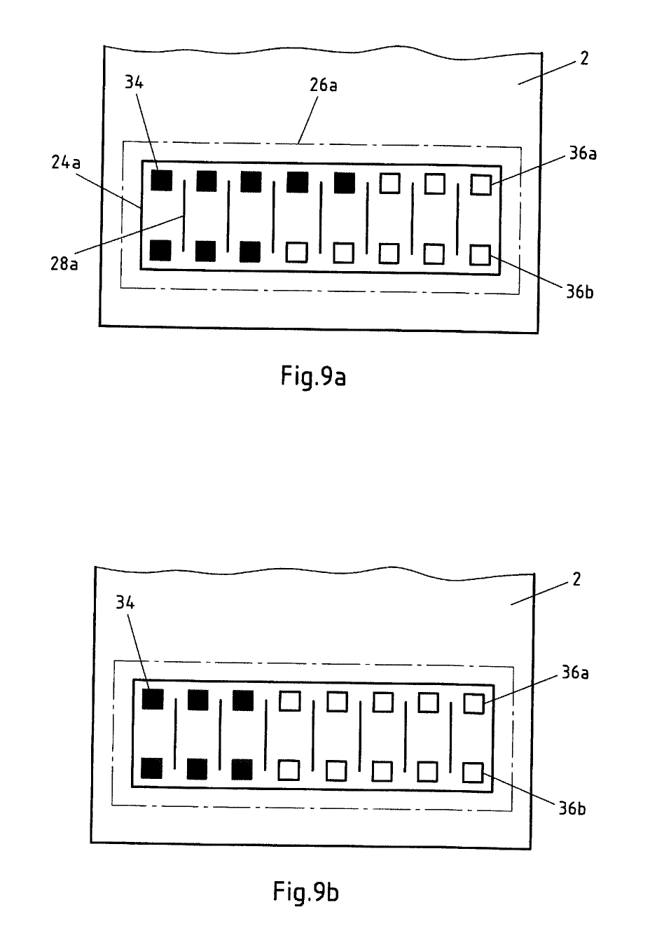

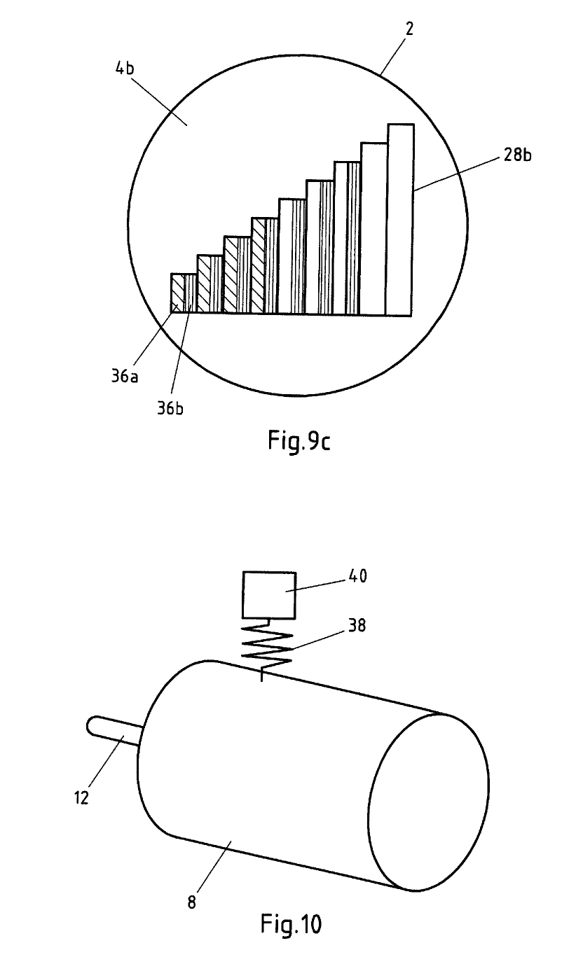

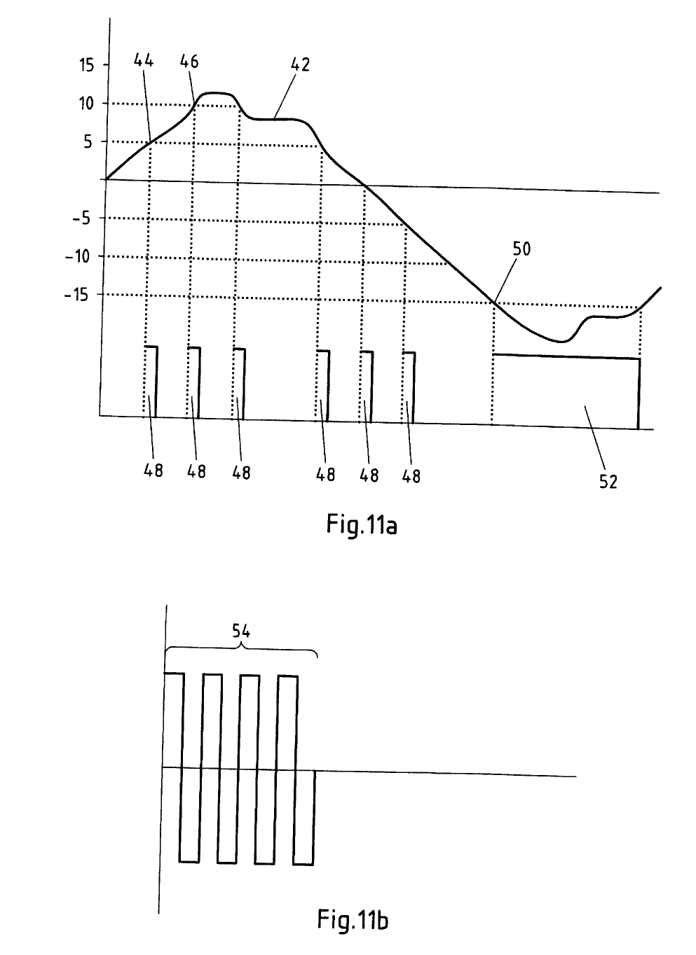

FIG. 8a shows a thermostat with frontal operation;

FIG. 8b shows a thermostat with a rotating movement as operation;

FIG. 9a shows a top view onto a thermostat with a temperature indication according to an embodiment;

FIG. 9b shows a top view onto a thermostat with an indication of a remaining time according to an embodiment;

FIG. 9c shows a front view of a thermostat with a temperature indication according to an embodiment;

FIG. 10 shows a diagrammatic view of a servomotor according to an embodiment;

FIG. 11a shows a course of an adjustment of a setpoint temperature together with control pulses for tactile feedback according to an embodiment; and

FIG. 11b shows a control pulse according to an embodiment.

### DETAILED DESCRIPTION OF THE INVENTION

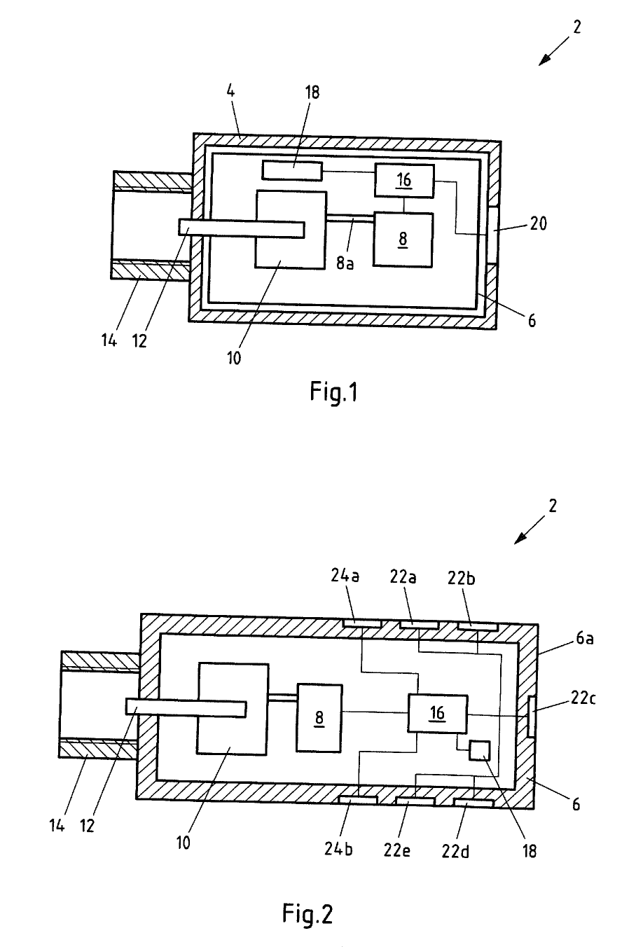

FIG. 1 shows a schematic sectional view of a thermostat 2 with motorised actuator.

The thermostat 2 comprises a housing 4 as well as a base body 6. Inside the base body 6 a motorised actuator 8 is arranged. The actuator 8 is connected by an axle 8a to a reduction gear 10. Via the reduction gear 10 a spindle 12 is moved in the axial direction. Arranged on the housing 4 is a screw connection 10, via which the thermostat 2 can be connected to a valve of a heating, air-conditioning and/or ventilation system. The spindle 12, when connected, is made to interact with the control valve of the heating element and the valve can accordingly be opened and closed via the actuator 8.

To control the actuator 8 and accordingly to set the volume flow through the valve, a control computer 16 is provided in the base body 6. The control computer 16 is programmed to carry out the processes described in the foregoing and in the following.

The control computer 16 generally is a microprocessor which can carry out a multitude of functions. The control computer 16 is connected to a temperature sensor 18. The temperature sensor 18 measures the actual temperature. To this end the temperature sensor 18 preferably comprises a temperature gauge which is arranged on the housing 4 or outside the housing 4, so as to measure the actual temperature in the vicinity of the housing 4 and not the temperature inside the base body 6.

In the control computer a setpoint temperature can be set. This can be done in the conventional way by means of, for example, a not illustrated turning wheel on the housing. It is also possible that the control computer 16 comprises communication means so as to communicate with a central control via the air interface. The control computer 16 can therefore, for example, receive via the air interface specifications for setpoint temperatures. This specified setpoint temperature can be compared with the actual temperature measured by the temperature sensor 18 and, depending on the result of the comparison the actuator 8 can be actuated. Through this the spindle 12 can be moved to and fro in the longitudinal direction in order to influence the valve setting of the heating element.

New type thermostats 2 have a display 20 on which, for example, the actual temperature, the setpoint temperature, the actual time and the like can be indicated. Generally the display 20 is a liquid crystal display which is controlled by the control computer 16.

As mentioned, with the conventional thermostats 2 the setting of the setpoint temperature takes place either via a thumbwheel on the thermostat 2 or from a remote-control computer. However, it is exactly the operation of a thumbwheel that is error-prone, seeing that dirt or encrustations can lead to errors. Moreover, users are nowadays accustomed to operating touch displays, where a change of a setting can be carried out by just a touch. Such touch displays generally operate with capacitive and/or resistive proximity sensors. In particular, capacitive proximity sensors are suitable for permitting contactless operations. According to an exemplary embodiment it is now possible for the thermostat 2 to also be equipped with such proximity sensors so as to permit a contactless setting of the setpoint temperature or other parameters. For this, as shown in FIG. 2, various measures are required on the thermostat 2.

FIG. 2 shows a base body 6 of a thermostat 2, which essentially is constructed similar to the thermostat according to FIG. 1. As can be noted in FIG. 2 the base body 2 is equipped with spindle 12, transmission 10, actuator 8 and control computer 16. Furthermore, a temperature sensor 18 is provided. In addition, however, proximity sensors 22a-e are provided on the base body 6. In the case of the example illustrated in FIG. 2, the proximity sensors 22a, 22b as well as 22e and 22d are arranged on the lateral surface of the base body 6. To this end grooves are provided in the lateral surface of the base body which are suitable to accommodate the proximity sensor 22. The proximity sensors 22a, b, d, e are suitable for detecting rotary movements around the rotary body 6, as will still be shown in the following. In addition to the peripheral proximity sensors 22, at the front 6a of the base body 6 a further proximity sensor 22c is provided. Also, this proximity sensor is arranged in a recess in the base body 6, so that it, the same as the other proximity sensors 22, closes off as flat as possible with the outer surface of the base body 6.

The proximity sensors 22 are connected to the control computer 16 via suitable control lines. By way of the control lines, the proximity sensors 22 receive electric power and give off a measuring signal to the control computer 16. The control computer 16 evaluates the signals of the proximity sensors 22 and concludes from these either a frontal approaching of the proximity sensor 22c, a peripheral approaching of at least one of the proximity sensors 22a, b, e, d or a rotary movement around the proximity sensors 22a, b, e, d. In particular in the case where the proximity sensors 22a, b, e, d detect an approaching of an object, e.g. a hand, the proximity sensor 22c will be deactivated by the control computer 1, so that same will not carry out any further evaluation until the proximity sensors 22a, b, e, d give off a signal that the object has been removed. This prevents that during a rotary movement around the peripheral proximity sensors 22, the front proximity sensor 22c will carry out an incorrect or unintentional measuring.

In the illustrated example the proximity sensors 22 are arranged in the base body 6. However, it is also possible for the proximity sensors 22 to be arranged on the base body and in particular in recesses inside the housing 4.

In addition to the proximity sensors 22, illuminants 24a, b are also provided. The illuminants 24a, b preferably are LED-strips which extend longitudinally and via the control computer 16 are controlled in such a way that also only sections can be activated and lit up, whereas other sections remain inactive and do not light up. Therefore, the illuminants 24 by activation of sections of different lengths can output values such as, for example, actual temperature, relative setpoint temperature and the like. It is understood that a respective length of a section is allocated to a respective temperature. This allocation preferably is dependent on a scale on the housing and can be permanently programmed.

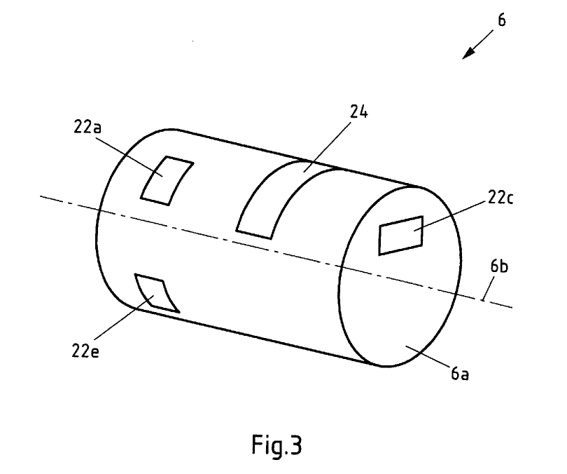

A possible arrangement of the proximity sensors 22 as well as of the illuminants 24 is illustrated in FIG. 3. FIG. 3 shows a view of a base body 6. It can be noted that in the area of an outer casing surface of the base body 6 two proximity sensors 22a, 22e are provided. The proximity sensors 22a, e are arranged here along a same peripheral line around the base body 6.

The base body 6 preferably is cylindrical and has a longitudinal axis 6b. The proximity sensors 22a, e preferably are arranged in defined angle distances around the longitudinal axis b. Preferably, when there are more than two proximity sensors, the respective angle distance between two proximity sensors is the same size, so that the proximity sensors are arranged as evenly divided as possible on the surface of the base body 6.

In addition, at least one illuminant 24 is provided in the base body 6. As can be noted, the illuminant 24 extends in an arc along the periphery of the base body 6. The circular segment spanned by the illuminant 24 preferably is between 45° and 90°. Alternatively or in addition to the illuminant 24 on the surface of the base body 6, an illuminant 24 can also be arranged at the front on the face 6a of the base body 6, but for simplicity sake this is not shown here.

On the face 6a of the base body 6 a further proximity sensor 22c is arranged. By way of the proximity sensor 22c an approaching of an object from the front can be detected, whereas by way of the proximity sensors 22a, e, a peripheral approaching of the base body 6 can be detected. By evaluating the measured signals of the proximity sensors 22a, e arranged on the periphery, especially by calculating the differences of the changes of the respective electric fields, a rotary movement of an object around the longitudinal axis 6b of the base body 6a can be detected. This rotary movement can be evaluated by the control computer 16 in such a way that a change of the setpoint temperature is carried out.

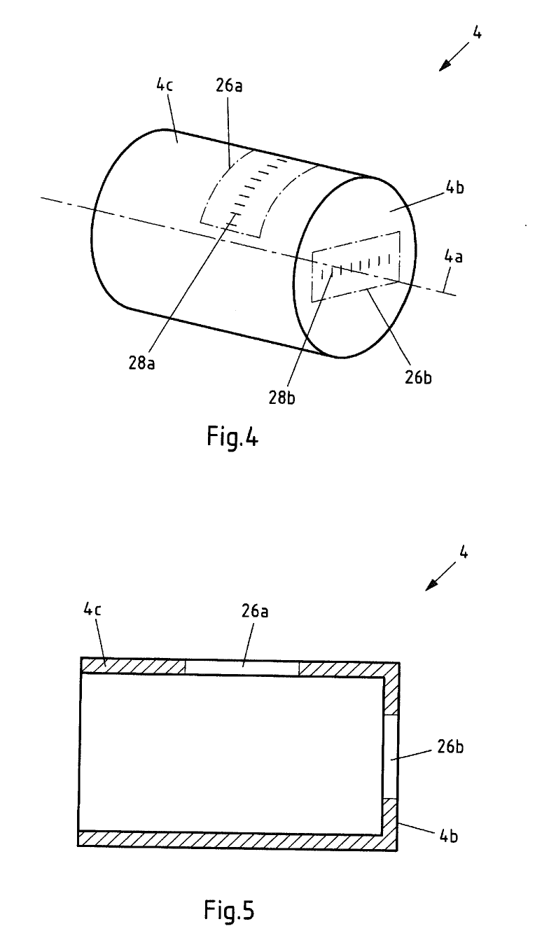

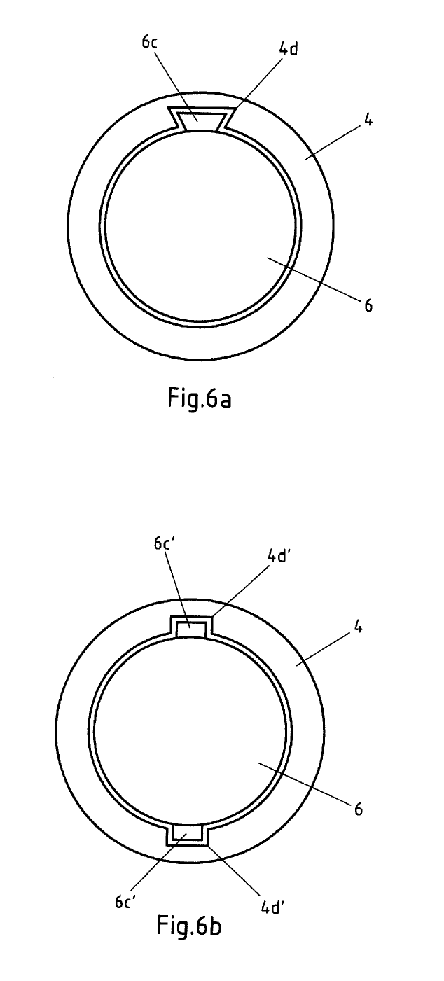

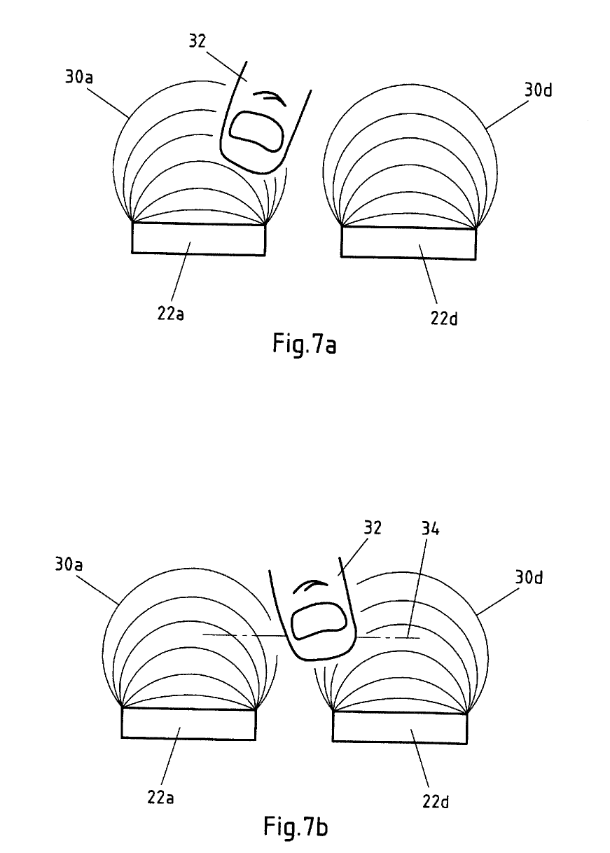

FIG. 4 shows a view of a housing 4. The housing 4 is hollow-cylindrical around a longitudinal axis 4a. The housing 4 has a base 4b and a cylindrical casing 4c.

The housing is at least in parts made of a translucent material. The opacity in some areas is such that the light from an illuminant 24 on the base body 6 can shine through, but details of the base body 6 cannot be recognised through the material. The translucent areas 26a, 26b are shown in FIG. 4. The area 26a extends along the casing 4c over an angular range of between 45° and 90° and has a longitudinal extent of about ⅓ to ¼ the length of the housing 4. In the areas 26 in each instance a scale 28a, b may be provided. It is understood that the areas 26a, 26b may be provided alternatively or commutatively.

The scale 28e comprises over the angle section of the area 26b an equal distribution of its scale marks, so that the angle section of the area 26a is divided into equal-sized sections by the scale 28a respectively its scale marks. With the aid of the scale 28a it is possible to show a temperature range of the heating system or the thermostat. A temperature range of between 10° C. and 30° C. can be possible, for example. This temperature range is divided into equal-sized sections, e.g. 20 sections. When then the section 26a spans an angle section of 40°, the scale 28a is such that per 2° angle a scale mark is provided, so that in total 20 scale marks of the scale 28a are provided in the area 26a.

Behind the area 26a the illuminant 24a is arranged on the base body 6, which illuminant covers an identical angle section as the area 26a. By controlling the illuminant 24a, sections of different lengths of the illuminant 24a can be activated and the scale 28a be lit up accordingly. Depending on the setting of the setpoint and actual temperature, via the scale 28a their relative position inside the temperature window formed by the thermostat 2 can then be read.

The same also applies, of course, to the area 26b, which is provided at the front and also comprises a scale 28b. Also, the scale 28b can permit an illustration of the temperature range of the thermostat 2.

FIG. 5 shows the translucent areas 26a, b in a schematic sectional view through the housing 4. It can be noted that the areas 26a, b are arranged on the housing 4c as well as on the base 4b.

In the installed state the housing 4 is arranged on the base body 6 in such a way that it cannot turn. Various locking mechanisms can be provided for this, which in the mounted state secure the housing 4 against turning on the base body 6. FIG. 6a shows such a possibility. Here it can be noted that a radially outwards pointing dovetail 6c is provided on the housing 6, which is pushed into a corresponding recess 4d on the housing 4. When the dovetail 6c engages into the recess 4d, then the housing 4 can no longer be turned around the longitudinal axis 6b of the base body 6 and the relative angle position between base body 6 and housing 4 is fixed.

A further variant is shown in FIG. 6b, where radially outwards pointing springs 6c′ are provided on the base body 6, which each engage into grooves 4d′ of the housing that extend along the longitudinal axis. Also by this a turning of the housing 4 relative to the base body 6 can be avoided.

For a contactless adjusting of the setpoint temperature or other parameters, as described, proximity sensors 22a to e are provided. The mode of operation of the proximity sensors 22 is illustrated schematically in FIGS. 7a and b. In FIG. 7a the proximity sensors 22a, 22d are shown, which each measure an electrical field in their environment. Thus, each of the proximity sensors 22a, 22d can be regarded as a plate for a condenser, the counterpart of which is the electrical field of the environment (the earth field). The two electrical fields of the proximity sensors 22a, 22d are illustrated in FIG. 7. When an object, e.g. a finger, approaches the electrical field 30a of the proximity sensor 22a, then the field strength of the field 30a changes. As a result thereof, the charge carriers on the proximity sensor 22a change position and density, which can be detected by a corresponding sensor. When a limit value of the change of the electrical field is exceeded, the proximity sensor 22a can therefore detect an object 32 in its vicinity and give off a corresponding signal. Also, the electrical field 30d of the proximity sensor 22d changes as a result of the object 32, but here the change may be so marginal that the proximity sensor 22d does not give off a corresponding signal.

When now the object 32 moves between the two proximity sensors 22a, 22d, as illustrated in the transition from FIG. 7a to FIG. 7b, then the field strengths of the two electrical fields 30a, 30d change. It can be seen to which extent the electrical field 30a has changed and it can at the same time be seen to which extent the electrical field 30d has changed. The respective changes as well as change directions can be evaluated and from this a movement of the object 32 along the axis 34 can be detected. The axis 34 preferably is parallel to connection lines between the proximity sensors 22a, 22d. With the aid of the adjacently arranged proximity sensors 22a, 22d, a movement of an object 34 along at least one axis can, therefore, be detected. By evaluating the corresponding sensor signals it can, therefore, be determined in which relation to the proximity sensors 22a, 22d the object 32 has moved.

The operation of an objective thermostat 2 is possible in a contactless manner with the aid of the proximity sensors 22. A user can operate the thermostat 2 by means of gestures. FIG. 8a illustrates a front-side operation. A user can with their hand 32 approach the base 4b of the housing 4 of the thermostat 2. The proximity sensor 22c arranged on the front 6a can detect this approach. In the control computer 16 the front-side operation is recorded based on the signal of the proximity sensor 22c. Next a tactile feedback can take place by a brief actuation of the actuator 8, which leads to a vibration of the thermostat 2. When the user touches the thermostat 2 with their hand, they can feel this tactile feedback. A brief touching or approaching at the front 6a can, for example, be used to activate an indication by way of the illuminants 24a, b. The indication can also be switched over by a brief touching or approach at the front, e.g. between setpoint temperature, actual temperature, outside temperature, atmospheric moisture and the like.

A long touching or approaching at the front by the hand 32 can also trigger another command in the control computer 16. It is possible, for example, that by a long touching an operating mode is changed. Thus, the setpoint temperature can either be set directly on the thermostat 2 by a rotary movement in the area of the housing, as illustrated in FIG. 8b (manual operation), or an automatic operation can be activated. Depending on which operating mode was activated, the tactile feedback may be different, e.g. by pulses of different lengths on the actuator 8. When the automatic mode is set, the thermostat 2 can receive a setpoint temperature from a central computer, independently of the manual setting on the thermostat 2 itself.

To change the setpoint temperature a user can with their hand 32, as illustrated in FIG. 8b, perform a rotary movement around the longitudinal axis 4a, which coincides with the longitudinal axis 6b of the base body 6. This rotary movement is detected by proximity sensors 22a, b, d, e arranged on the casing. The movement can be sensed corresponding to the evaluation of the change in the electric fields as shown in FIG. 7. During the rotary movement of the hand 32 illustrated in FIG. 8 the housing 4 does not rotate but remains fixed to the base body 6, which is firmly attached to the heating element. Just the rotary gesture leads to a change in the setpoint temperature.

For example, per defined angle section of the rotary movement, e.g. per 5° rotary movement, the setpoint temperature will be changed by 1° C. During a rotary movement which exceeds a defined angle section, an impulse can be transmitted to the actuator 8 so as to permit a tactile feedback.

It is also possible to specify a maximum and a minimum control value of the setpoint temperature. If this value is reached by a rotary movement and the rotary movement continues, it can be determined by the control computer 16 that the limit of the setting range has been reached. In this case, for example, a permanent activation of the actuator for the tactile feedback can take place.

It is understood that during the activation of the actuator 8 for the tactile feedback this is always operated oscillatingly so as to prevent that the spindle 12 is changed significantly in its position.

When the user with their hand 32 approaches the outer surface 4c of the housing 4, as shown in FIG. 8b, this is detected by the proximity sensors 22a, b, d, e and the proximity sensor 22c can, for example, be switched off. Also, when the hand 32 approaches the thermostat 2, an activation of the illuminants 24 can take place by the control computer 16, so that only in the case of an operation and, where applicable, after a predefined follow-up time, the illuminants 24 are activated.

FIG. 9 shows the representation of a display by means of an illuminant 24a. The illuminant 24a is formed by several light-emitting diodes arranged behind one another. Preferably, the illuminant 24a has two rows 36a, 36b of light-emitting diodes 34. Each row 36a, 36b can also be understood as an independent illuminant. The rows 36a, 36b extend parallel to one another and form a bar of light-emitting diodes 34. As can be seen from FIG. 9a, the Illuminant 24 is arranged in the area of the scale 28a. In particular, the scale 28a and the illuminant 24a are arranged in the translucent region 26a of the housing 4.

The two rows 36a, 36b can be formed by light-emitting diodes 34 of different colour. For example, the row 36a can be formed by green light-emitting diodes and the row 36b can be formed by red light-emitting diodes.

If a user approaches the thermostat 2, as shown in FIG. 8a, this approach can be detected. The control computer 16 can activate the illuminant 24a so that the number of activated light-emitting diodes (shown by black dots) in the row 36a represent a setpoint value for the temperature. In addition, in the row 36b, the number of activated light-emitting diodes 34 can represent an actual value of the temperature. If no light-emitting diode is activated in row 36, the user can conclude that the actual temperature has reached the lowest limit value for the thermostat, e.g. 10° C. If all light-emitting diodes 34 of the row 36b are activated, the user can conclude that the actual temperature has reached the maximum temperature range of the thermostat, e.g. 30° C. The same applies to the rows 36a and the set setpoint temperature.

By means of a rotary movement, as illustrated in FIG. 8b, the control computer 16 detects a change in the setpoint temperature in the direction of higher or lower values. Depending on the direction of rotation, the setpoint temperature is increased or decreased, which results in the activation of more or less light-emitting diodes 34 in the row 36a. The user is thus given an optical feedback of a change of the setpoint temperature by the length of the section in the row 36a in which the light-emitting diodes 34 are activated. When a respective scale section of the scale 28a is exceeded, a tactile feedback can take place, so that the user can recognise without looking that they have changed the setpoint temperature by a specific value.

If the setpoint and actual temperature are identical, this can initially be illustrated by the fact that the number of activated light-emitting diodes 34 per row 36a, b is the same. Furthermore, for example, a flashing of the light-emitting diodes 34 can be activated by the control computer 16. Also, another type of tactile feedback can take place, e.g. by a longer or shorter vibration, or a vibration with a different frequency.

It is also conceivable that a further row of light-emitting diodes 34 is provided, which indicate in a further colour, for example yellow, that the setpoint and actual temperature are identical. This further colour can also be used to illustrate a change in the setpoint temperature compared to the previous setpoint temperature. The other colour can indicate the span by which the setpoint temperature was changed.

FIG. 9b shows the thermostat 2 at the moment when the user removes their hand 32 from the thermostat 2. This removal can be detected and the control computer 16 can estimate how long it will take until the setpoint temperature and the actual temperature are the same. The control computer 16 can do this by using a heating model which is parameterised for the room in question. Depending on the heat capacity of the room as well as the supply temperature of the heating element and the radiation characteristics of the heating element, it can be estimated how long it will take until the actual temperature has reached the setpoint temperature.

As a measure for the time, for example, the light-emitting diodes 34 of the row 36a, b can be activated. The more light-emitting diodes 34 in the rows 36a, b are activated, the longer the estimated time. Also, the scale 28a can, for example, be used here. A maximum time may, for example, be 30 minutes, a minimum time may, for example, be 0 minutes. The quotient of estimated time to the maximum time can indicate which numbers of light-emitting diodes 34 are activated. If the quotient is greater than 1, all light-emitting diodes are activated. If the quotient is, for example, 0.5, i.e. a heating time of 15 minutes is estimated, exactly half the light-emitting diodes of a respective row 36a, 36b can be activated.

FIG. 9c shows the possibility of a frontal display with a scale 28b. The scale 28b is formed of bars of different lengths, behind each of which two rows of light-emitting diodes 36a, 36b are arranged. In each instance on the left side of a bar of the scale 28b, a row 36a can be arranged which represents the actual temperature, and in each instance on the right side a row 36b may be provided which represents the setpoint temperature. From FIG. 9 it can be noted that the setpoint temperature is greater than the actual temperature, which is indicated by a corresponding activation of the LEDs 34 of the row 36a, 36b.

The tactile feedback can take place via the actuator 8 or via an additional motor inside the base body 6. FIG. 10 shows by way of example how such a tactile feedback can take place via the actuator 8. The actuator 8 has on its housing a flywheel mass 40 supported by a spring 38. By way of the spring 38 and the flywheel mass 40 as well as the dynamic behaviour of the actuator 8 itself, a resonance frequency of the actuator 8 can be set, which in particular is identical to the frequency of the pulse which is transmitted by the control computer 16 for the tactile feedback to the actuator 8. Such a pulse may have an alternating voltage which at a specific frequency, e.g. between 50 and 200 Hz, drives the actuator 8 and thus moves the axis 8a back and forth at the corresponding frequency. As a result, the flywheel mass 40 and the spring 38 are activated and brought into resonance so that an as strong as possible vibration can be noted on the thermostat 2.

FIG. 11a shows a sequence of an adjustment of a setpoint temperature together with the respective control pulses of the control computer 16 to the motor 18 for the tactile feedback signal. Shown is the course of a setpoint temperature 42 starting from a base temperature, e.g. 20° C. The change in the setpoint temperature 42 is effected via a rotary movement, as described in the foregoing. When the setpoint temperature exceeds a certain limit, a control pulse is to be triggered by the control computer 16. In the illustrated example, for the sake of simplicity, only an interval of in each instance 5° C. is specified, on the exceeding of which a control pulse must be output. Of course, smaller or larger intervals are possible, in particular intervals in steps of one degree or half a degree. In the example shown in FIG. 11a, the setpoint temperature 42 is, for example, constantly increased from the base temperature, first by 5° C. and then by 10° C. At the times 44, 46, the setpoint temperature exceeds a limit value, here 5° C. and 10° C. respectively, which results in a control pulse 48 being triggered at the time 44 as well as at the time 46. The same applies to the further course of the changing of the setpoint temperature 42, during which, whenever an interval limit is exceeded, a control pulse 48 is triggered.

At the time 50, the setpoint temperature falls below a lower limit range. However, the user can still carry out a further rotary movement and virtually reduce the setpoint temperature further. In the control computer 16, however, the setpoint temperature then remains at the limit value until an operation takes place in the other direction. However, since at the time 50 the lower limit value has already been exceeded, a longer control pulse 52 can be emitted. This can, for example, be emitted for as long as a change in the desired temperature 42 is made and this lies below the lower limit. The same also applies, of course, to an upper limit. If the user stops operating the thermostat 2, i.e. there is no rotary movement, the pulse 52 can be ended. The same also applies, of course, to an exceeding of the upper limit. Due to the long pulse, the user directly receives a permanent tactile feedback that they cannot change the setpoint temperature further in the direction desired by them.

A profile of a pulse 48 and a pulse 52 respectively is shown in FIG. 11b. It can be seen that the pulse is formed from an alternating voltage which, for example, swings with a frequency of 100 Hz around the zero point. The duration 54 of a pulse is dependent on whether a short pulse 48 or a long pulse 52 is activated by the control computer 16. By the activation of the actuator 8 with the pulse according to FIG. 11b, the actuator is oscillated without the spindle 12 being moved significantly out of its previous position.

### LIST OF REFERENCE NUMERALS

2 Thermostat
4 Housing
4a Longitudinal axis
4b Base
4c Casing
6 Base body
6a Front
6b Longitudinal axis
8 Actuator
10 Transmission
12 Spindle
14 Screw connection
16 Control computer
18 Temperature sensor
20 Display
22a-e Proximity sensors
24a, b Illuminants
26a, b Areas
28a, b Scale
30 Electric field
32 Hand
34 Light-emitting diode
36a, b Rows
38 Spring
40 Flywheel mass
42 Setpoint temperature
44, 46 Time
48 Pulse
50 Time
52 Pulse
54 Duration

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A thermostat for heating, air-conditioning and/or ventilation systems comprising:
a base body,
a temperature sensor arranged on the base body,
a motor driven actuator arranged on the base body, to adjust a control value of the heating, air-conditioning and/or ventilating system, and
a housing enclosing the base body at least partially,
wherein the housing in the area of the base body is at least in part made of a translucent material.

2. The thermostat of claim 1, wherein the translucent material has an opacity of at least 1.5.

3. The thermostat according to claim 1, wherein on the base body, on the side facing the housing, in the area of the translucent material of the housing at least one two-colour illuminant is arranged.

4. The thermostat of claim 3, wherein the illuminant is bar-shaped.

5. The thermostat of claim 3, wherein the illuminant is arranged in the area of a scale arranged on the housing.

6. The thermostat of claim 3, wherein a control circuit controls the illuminant in dependence on a setpoint temperature and an actual temperature determined by the temperature sensor.

7. The thermostat of claim 6, wherein the control circuit actuates the illuminant in dependence on a comparison of the actual temperature with the setpoint temperature.

8. The thermostat of claim 3, wherein the control circuit in dependence on a comparison of the actual temperature with the setpoint temperature estimates a time until the actual temperature will reach the setpoint temperature and actuates the illuminant in dependence on the estimated time.

9. The thermostat of claim 3, wherein the control circuit actuates the illuminant in such a way that a length of an activated section of a colour of the illuminant corresponds to a temperature or a time.

10. The thermostat of claim 3, wherein the control circuit during a change of the setpoint temperature actuates the illuminant in such a way that a first colour represents the previous setpoint temperature, a second colour the change of the setpoint temperature, and a third colour the new setpoint temperature.

11. The thermostat of claim 1, wherein the housing is, at least in parts, hollow cylindrical with a base and a casing.

12. The thermostat of claim 1, wherein the housing is held on the base body in such a way that it cannot turn in relation to the base body.

13. The thermostat of claim 1, wherein on the base body at least one sensor is arranged, with which a rotary movement of at least one object in the area of the outside of the housing around the longitudinal axis of the housing can be detected.

14. The thermostat of claim 2, wherein the translucent material has an opacity of at least 2 and less than 10.

15. The thermostat of claim 2, wherein the translucent material has an opacity of less than 10.

16. The thermostat of claim 5, wherein the scale is arranged in the area of the casing of the housing or in the area of the front of the housing such that the scale is stationary relative to the illuminant.

17. The thermostat of claim 6, wherein the control circuit actuates a first colour of the illuminant in dependence on the setpoint temperature and/or the control circuit actuates a second colour of the illuminant in dependence on the actual temperature.

18. The thermostat of claim 17, wherein the control circuit actuates the first colour and the second colour simultaneously.

19. The thermostat of claim 7, wherein, at a falling below a minimum distance between the actual temperature and setpoint temperature, a third colour of the illuminant is actuated or the illuminant is actuated in a pulsed manner.

20. The thermostat of claim 11, wherein the housing is arranged with its base at the front on the base body.
